(19) United States
(12) Patent Application Publication
(10) Pub. No.: US 2005/0175843 A1
(43) Pub. Date: Aug. 11, 2005

(54) Bright formable metalized film laminate

(76) Inventor: John R. Johnson, Valparaiso, IN (US)

Correspondence Address: CHRISTIE, PARKER & HALE, LLP, PO BOX 7068, PASADENA, CA, 91109-7068, US

(21) Appl. No.: 10/979,451

(22) Filed: Nov. 2, 2004

Related U.S. Application Data
(63) Continuation-in-part of application No. 10/429,015, filed on May 2, 2003, now abandoned.

(51) Int. Cl. B32B 27/00

(52) U.S. Cl. 428/423.1

(57) ABSTRACT

A bright metal laminate comprises a highly reflective metal layer applied to a supporting baseweb comprising a flexible thermoplastic and thermoformable polyurethane film. The metal film comprises indium or an alloy of indium and is applied to a surface of the baseweb by vapor deposition techniques. An optically clear polymeric outer layer of preferably acrylic, PETG or polycarbonate resin is laminated in free-film form to the exposed surface of the metalized film under heat and pressure to bond the outer layer to the metal film. The surface of the polyurethane baseweb is sufficient to produce adhesion of the metal layer to the baseweb in the absence of an intervening bonding layer or surface treatment, while smoothing out the metal layer to a mirror-like finish under lamination to produce a reflective laminate having a distinctness-of-image (DOI) greater than 95. The laminate can be thermoformed to a three-dimensional shape while retaining its high DOI level.

### CROSS REFERENCE TO RELATED APPLICATIONS

This application is a continuation-in-part of application Ser. No. 10/429,015, filed May 2, 2003.

### FIELD OF INVENTION

This invention relates to bright metalized film laminates, and more particularly, to a formable metal laminate having a high degree of reflectivity, in which the laminate can be thermoformed to a three-dimensional shape while retaining a mirror-like appearance.

### BACKGROUND

Highly reflective metalized polymeric laminates can be used as substitutes for reflective metal parts having chrome-plated surfaces. The automotive industry is an example where decorative metalized polymeric laminates have been used as substitutes for chrome-plated exterior parts such as trim parts, body side moldings, emblems or badges, and the like. Decorative metal laminates also can be used for interior automotive parts such as on dashboards, for example.

Decorative metalized polymeric laminates have been used successfully in the past because plastic parts are relatively flexible, weather-resistant, inexpensive and they can reduce vehicle weight.

In the past, these metalized laminates have been made by metalizing a plastic film and applying protective and supporting or reinforcing layers to form a multi-layer reflective metal/plastic composite. The flexible laminate then can be thermoformed to a three-dimensional shape and subsequently bonded to a molded polymeric substrate sheet.

Some reflective metal laminates are not adequately thermoformable to a three-dimensional shape. Such reflective metal laminates, when formed to a three-dimensional shape, lose their flexibility, causing the metal layer to fracture or suffer loss of reflectivity. Inter-layer adhesion problems such as delamination also can develop during such forming or otherwise during use.

The present invention provides a metalized multi-layer polymeric laminate having a high degree of reflectivity or distinctness-of-image (DOI). The laminate can be thermoformed while still retaining its chrome-like appearance and while maintaining superior inter-layer adhesion.

### SUMMARY OF THE INVENTION

Briefly, one embodiment of the invention comprises a bright metal laminate which includes a highly reflective metal layer applied to a supporting baseweb layer comprising a flexible thermoplastic and thermoformable polyurethane film. The metal layer comprises indium or an alloy of indium and is applied to the surface of the baseweb by vapor deposition techniques. An optically clear polymeric outer layer preferably containing an acrylic, polycarbonate, or PETG resin is laminated in free-film form and under heat and pressure to the exposed surface of the metalized film supported on the baseweb. The lamination step bonds the outer layer to the metal layer but also enhances reflectivity of the metal. The polyurethane baseweb promotes adhesion of the metal layer to the baseweb in the absence of an intervening bonding layer or surface treatment, while lamination smoothes out the metal layer to a mirror-like finish that produces a reflective laminate having a distinctness-of-image greater than 95. The laminate can be thermoformed to a three-dimensional shape while retaining its high level of distinctness-of-image over 95. Highly reflective shaped articles having excellent optical clarity and DOIs over 99 can be produced.

These and other aspects of the invention will be more fully understood by referring to the following detailed description and the accompanying drawings.

### BRIEF DESCRIPTION OF THE DRAWINGS

FIG. 1 is a schematic cross-sectional view illustrating a multi-layer bright metalized film laminate according to principles of this invention.

FIG. 2 is a schematic cross-sectional view illustrating a bright metalized film laminate and molded substrate composite that has been thermoformed to a three-dimensional shape.

FIG. 3 is a schematic cross-sectional view illustrating a three-dimensionally shaped automotive part having a reflective metal surface and a molded substrate.

### DETAILED DESCRIPTION

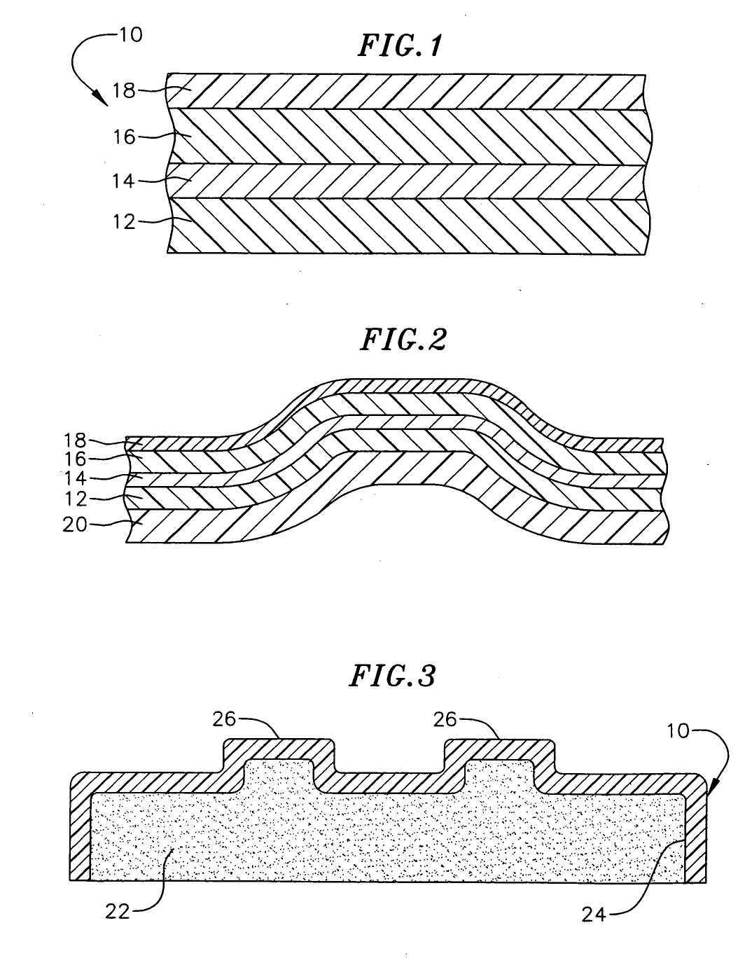

FIG. 1 illustrates a bright metalized film laminate 10 according to principles of this invention. The laminate can be thermoformed into a three-dimensional shape and still retain a highly reflective chrome-like appearance. The laminate comprises a flexible thermoformable and thermoplastic polymeric baseweb layer 12, a reflective metal layer 14 bonded to the baseweb layer 12, and an optically clear polymeric outer layer or top layer 16 bonded to the side of the metal layer opposite from the baseweb. An optional protective polymeric over-laminate 18 can be bonded to the outer surface of the top layer.

The clear outer layer 16 comprises a flexible self-supporting sheet or film of a thermoformable and thermoplastic polymeric material. The sheet is non-elastomeric and formable to a self-sustaining shape. The preferred thermoplastic materials contain acrylic or polycarbonate resin or a copolyester resin, preferably glycol-modified polyethylene terphthalate (PETG) resin. The outer layer comprises a continuous sheet or film having high temperature resistance sufficient for withstanding lamination under heat and pressure and thermoforming sheet temperatures as described below. In one embodiment the outer layer is a semi-rigid sheet having a thickness from about 5 to about 20 mils, and more preferably from about 7 to about 15 mils, for laminates that are subsequently injection molded. The acrylic outer layer can generally have a thickness in the range from about 2.5 to 20 mils. The polycarbonate layer can have a thickness generally in the range from about 7 to 20 mils. The PETG sheet can have a thickness from about 5 mils up to about 20 mils. For thick sheet forming (in which the laminate is not injection molded to a separate substrate), the PETG layer can have a thickness from about 40 mils to about 60 mils. In embodiments where a supporting thermoplastic backing layer is laminated to the urethane sheet prior to thermoforming (as described below), the outer layer can have a thickness below about 7 mils. Generally speaking, the thicker the clear outer layer, the better the metallic appearance of the final laminate, following the lamination step described below.

The clear outer layer is sufficiently semi-rigid to provide a reinforcing layer for subsequent thermoforming, lamination and molding steps. The outer layer is sufficiently thermoformable to be capable of retaining a three-dimensional shape after the composite sheet material is thermoformed at temperatures raising the sheet temperature of the laminate to 270° F. to 370° F. The outer layer also is optically transparent and essentially gel free to enhance the optical properties of the bright metal laminates.

In one embodiment, the preferred sources of the acrylic outer films are high gloss polymethylmethacrylate resins identified as Sumitomo S001, Kaneka SD009 or SD010 and Mitsubishi Rayon N47. The preferred polycarbonate film is Bayer DE1-1. A preferred PETG material is a clear amorphorus thermoplastic sheet with high stiffness, hardness and toughness, and in one embodiment, the PETG material is available as grade 6763 from Eastman Corporation.

The outer film or sheet also has good adhesion to the metal surface, and in one embodiment, the interface bond strength is more than about 10 pounds per inch.

The metal layer 14 is applied to the baseweb 12 by vapor deposition techniques (which can include E-beam or thermal deposition). The metal layer preferably comprises indium but also can include alloys of indium, such as indium/tin or indium/silver alloys, and in some applications tin can be used. Indium (and alloys with a high indium content) has a more desirable chrome-like appearance. Indium is also preferred because it is a soft metal having a melt temperature of about 155° C. (311° F.) which causes the layer of indium to flow properly during the lamination and thermoforming steps described below. Indium has a melt point that allows it to flow during lamination to deform at thermoforming temperatures (270-370° F.) and still maintain a chrome-like appearance.

The metal layer is formed on the baseweb as a continuous thin film of uniform thickness. As mentioned, the metal layer is preferably deposited by vapor deposition techniques, typically by applying a molten metal under vacuum by such techniques as electron beam evaporation, sputtering, induction heating, or thermal evaporation. All of these deposition techniques are referred to generally as vapor deposition. The metal is deposited at a layer thickness that forms a continuous metal film, one in which the metal is initially deposited as closely spaced discrete metal islands but further deposited or allowed to spread out to such an extent that the layer becomes an uninterrupted thin reflective metal film. The indium is preferably deposited at a layer thickness of 1.0 gram per square meter or less. Stated another way, the indium layer thickness ranges from about 200 to about 1,600 angstroms (20 to 160 nm), more preferably, about 400 to about 1000 angstroms (40 to 100 nm). In one embodiment in which the metal layer is applied by thermal deposition, a layer thickness from about 400 to about 800 angstroms (40 to 80 nm) produced highly reflective metal films.

The indium film is applied to achieve a highly reflective, optically continuous metallic appearance. The objective is not to achieve an opaque metal layer because indium, when applied too thick, can have a cloudy appearance. Preferably, optical density is the parameter to be measured for adjusting to achieve a desired metal film thickness; and in one embodiment, desired optical density is from about 0.6 to about 1.6, and more preferably, about 1.0 to about 1.3, when measured on a MacBeth model TR927 densitometer.

The thickness of the metal film also can be characterized by its visible light transmittance. In one embodiment of the invention, the visible light transmittance of the metal film was measured across the range of the visible spectrum: approximately 400 to 700 nm wavelength. At 700 nm the light transmittance was about 14%; at 400 nm the light transmittance was about 2%. The light transmittance increase was almost linear between the 400 and 700 nm end points.

In some embodiments involving films of greater thickness within the 200 to 1,600 angstroms range, the visible light transmittance of the film is more desirably within the 2% to 8% range where the metal film tends to undergo thinning in higher draw applications.

The baseweb layer 12 comprises a flexible thermoplastic and thermoformable film or sheet. In one embodiment, the baseweb comprises a polyurethane resin. An alphatic urethane film is presently preferred although an aromatic urethane film also can be used. Generally speaking, the polyurethane layer has several advantages with respect to metalization, lamination and thermoforming. In one embodiment, the polyurethane baseweb has a surface roughness and the surface of the polyurethane baseweb is inherently tacky, which results in excellent metal adhesion. The metal is applied in direct contact with the tacky surface of the polyurethane baseweb. No corona or plasma treatment or adhesive layers are necessary to enhance adhesion of the metal film to the baseweb. The metalized urethane surface still retains some tackiness which helps in subsequent lamination to the outer layer 16 as described below. Although the urethane has a high surface roughness during the metalization process, it smoothes to a mirror-like surface during the applied heat and pressure of the lamination process. The urethane film is very flexible which enables it to easily assume a three-dimensional shape during thermoforming, and the composite construction of the top layer/metal layer/urethane layer has excellent intercoat adhesion. The peel strength at the interface of the metal film 14 and the outer layer 16 is greater than 10 pounds per inch, and in one embodiment, the peel strength is in excess of 40 pounds per inch.

More specifically, one embodiment of the urethane baseweb film has a high coefficient of friction sufficient to produce the tacky deposition surface. The surface of the otherwise continuous layer of vapor deposited indium has many surface peaks and valleys when viewed on a microscopic scale. The surface is characterized as fairly bumpy at the microscopic level but is not composed of discrete islands which are separated or isolated from each other. Microphotographs have shown that the surface of the indium metalized on a smooth surface of a PET film also is characterized by peaks and valleys. The surface roughness of the baseweb causes improved adhesion of the metal to the underlying urethane baseweb film, and as mentioned, no surface treatment or adhesive tie coat layers are necessary to achieve sufficient bonding of the metal to the urethane layer. The heat and pressure of lamination (described below) causes the metal layer to flow and smoothes the metal layer to a mirror-like surface having a DOI in excess of 95. Test data has shown DOIs in excess of 99. DOI of the initial metalized surface can be as low as 60 prior to lamination.

The preferred thickness of the polyurethane baseweb layer is from about 2 to about 8 mils. The polyurethane baseweb is preferably supported by a releasable polyester (PET) carrier film which allows better processing during metalization and subsequent lamination.

The presently preferred polyurethane baseweb material is an extrusion grade thermoplastic urethane resin film. The preferred urethane baseweb material is an optically clear sheet stock film made by Deerfield Urethane, a Bayer company, South Deerfield, Mass., Product No. A3600, an aliphatic polyester polyurethane film having a Shore A hardness of 92, a peak melting point of 98° C. (208° F.), a glass transition temperature of −16° C., and an ultimate elongation of 550%. Peak melting point is measured by DSC (Differential Scanning Calorimeter) and Tg is measured by TMA (Thermal Mechanical Analysis). An alternative source of the urethane film is J.P. Stevens, Product No. SS-1219.

In one embodiment, the glass transition temperature (Tg) of the polyurethane baseweb is below about 0° C. The melt temperature is between about 90° C. and about 110° C. The baseweb can flow with the other layers during the thermoforming process and the metalized baseweb has good adhesion to the acrylic, polycarbonate or PETG outer layers during lamination and thermoforming. The Tg of this particular baseweb material also enhances adhesion to the metal film. The baseweb material has a Shore A hardness above 80 and more preferably above 85, which provides better adhesion than similar urethane films of lower hardness. The combined properties of the aliphatic polyester urethane film provide a desirable combination metal adhesion, clarity, hardness and thermoformability.

The clear outer layer 16 is laminated to the exposed outer surface of the metalized urethane baseweb. As mentioned, the lamination step bonds the metal layer to the underside of the clear outer layer and smoothes the metal to produce a DOI which can be in excess of 99. Melting or flow of the polymer layers and metal layer most likely occurs during lamination, which smoothes the metal layer to its highly reflective chrome-like appearance. In one embodiment, a hot roll temperature of at least 400° F. and a roll pressure of about 700 pounds per square inch are used for the lamination step. In some instances, an adhesive tie coat layer may be used between the metal layer and the outer layer to improve adhesion.

The protective over-laminate 18 can be permanently bonded to the outer surface of the polycarbonate or PETG clear outer layer 16. The over-laminate can improve outdoor weathering properties of the polycarbonate layer. A polyvinylidene fluoride/acrylic (PVDF/acrylic) alloy film has been found to be effective as an over-laminate, especially in retarding yellowing of the polycarbonate or PETG. In one embodiment, the PVDF component comprises Kynar 500 Plus from Atofina and the acrylic component comprises Elvacite 2042 from Ineos. A weight ratio of 50% to 70% PVDF and 30% to 50% acrylic for the PVDF/acrylic alloy is preferred The preferred thickness of the PVDF/acrylic over-laminate is about 0.5 to about 2.0 mils. A small amount (2 phr or less) of UV absorber can be dispersed in the over-laminate. The over-laminate also can resist loss of gloss in the polycarbonate outer layer. The over-laminate can be adhered to the outer layer by an intervening adhesive tie coat layer. The acrylic clear outer layer 16 can be used without such an over-laminate since it typically has inherently better weathering resistance than the polycarbonate or PETG.

The over-laminate can be tinted with an appropriate level of pigment to provide coloration in certain applications. The over-laminate also can have one or more undercoated print layers for various desired print designs, as described below.

The laminate 10 of FIG. 1 can be thermoformed to a three-dimensional shape as illustrated in FIG. 2. The thermoforming tool (not shown) applies heat and pressure to vacuum-form the laminate to a three-dimensional shape, causing elongation of the metal and polymer layers to produce the desired shape. The preferred sheet temperature of the laminate during thermoforming is between about 270° F. to about 370° F. The appearance of the finished part is improved when the urethane baseweb is formed against the face of the thermoforming tool. The composite laminate can stretch up to at least 100% during thermoforming without suffering any fracture in the metal layer or otherwise degrading its DOI level. Tests have shown that DOI of the laminate is maintained above 95 during the thermoforming step and finished shaped parts have DOIs in excess of 99.

The rigidity of the acrylic, polycarbonate, or PETG outer layer 16 provides a reinforcing sheet that assists in thermoforming the composite laminate to a finished three-dimensional shape. Stated another way, the composite laminate (outer clear layer 16, metal layer 14 and baseweb 12) is non-elastomeric and thermoformable to a shape-sustaining form. The melt temperatures of the metal layer 14 and polyurethane baseweb 12 are lower than the thermoforming sheet temperature, causing the metal and urethane to flow at the interfaces sufficiently to form a good bond at each interface. The Tg and melt temperature characteristics of the urethane baseweb also enhance stretching of the baseweb during thermoforming, while the metal layer elongates properly to maintain its highly reflective, high DOI optical properties. The thickness of the formed outer layer also enhances DOI of the finished shaped laminate.

In subsequent operations, a supporting substrate sheet 20 can be molded and bonded to the urethane baseweb side of the formed laminate to produce a finished part. The substrate sheet material comprises a molded polymeric resin such as ABS, polycarbonate, thermoplastic elastomer such as thermoplastic polyolefin or thermoplastic urethane, or acrylic resin, which can be injection molded to the thermoformed laminate, for example, in an insert-mold process. Certain adhesive coatings can be applied to the underside of the urethane baseweb to enhance adhesion to the substrate sheet. For instance, CPO adhesives can be used to bond the laminate to a TPO substrate sheet. In one embodiment, peel strength at the interface of the baseweb and substrate sheet is more than about 8 pounds per inch. Release coat materials also can be applied to the exposed surface of the urethane baseweb to allow better release from a thermoforming mold.

Alternatively, the molded substrate resin material can be poured into the thermoformed cavity of the previously shaped laminate to form a structural base for an automotive part. An adhesive can be applied later for making finished shaped parts such as automotive emblems or badges. In this embodiment, a crosslinkable urethane resin, a thermoplastic elastomer, or an acrylic resin can be used as the substrate resin sheet material.

FIG. 3 illustrates such an alternative use of the invention in which the bright metal laminate 10 has been thermoformed to a three dimensional shape and bonded to a molded substrate material 22. In this embodiment, thermoforming of the laminate first forms a cavity 24 on the underside of the shaped laminate. The top surface of the laminate in FIG. 3 is shown in cross-section with projected areas 26 forming a shaped exterior design for the finished part, such as an automotive badge or emblem. The shaped laminate is then inverted and the molding material in fluid form is poured into the cavity to fill the void and form a more rigid substrate after hardening or curing of the molding material. An adhesive layer (not shown) such as a pressure sensitive adhesive can be applied to the bottom face of the molded substrate for use in attaching the badge or emblem to an automobile body or the like.

Further details on the process and construction of the automotive badge of FIG. 3 are described in a U.S. patent application entitled “A Three Dimensional Automobile Badge,” inventor John Richard Johnson, which is incorporated herein by this reference. This application is assigned to the assignee of the present application and has the same filing date as the present application, with an Express Mail No. EV164825330US.

The bright metalized finished part can be used for other exterior automotive applications, such as automotive trim parts, body side moldings and grills. The finished part also can be used for interior automotive trim applications.

In one embodiment, a coating is used on the underside of the polyurethane film where it contacts the injection-molded resin. A thin coating of a thermoplastic resinous material such as an acrylic resin film can be understamped on the urethane film. This coating improves release of thermoformed urethane parts from the thermoforming mold and also does not negatively affect adhesion to the injection molded resin such as an ABS resin.

A similar understamped coating of CPO and acrylic resin films can improve release from the thermoforming mold and bonding to a TPO injection molded material.

In another embodiment, a thin thermoplastic polymeric backing sheet from about 5 to about 20 mils in thickness can be bonded to the underside of the polyurethane film. This backing sheet can prevent penetration of the injection-molded resin into the metalized layer of the composite.

Print coats in various patterns can be applied above the metal layer. In one embodiment, print layers in various designs such as geometric patterns can be applied by lamination techniques to a the top surface of the outer layer. The reflective metal layer, below the transparent outer layer, shows through as a background behind the printed design. In one embodiment, the print coat comprising one or more print layers is applied by gravure printing to the underside of a separate clear protective film which can comprise a PVDF/acrylic top coat film release coated on a PET carrier as described previously. The top coat layer is applied to the carrier followed by applying the print coat layers to the top coat. These layers are then transfer laminated and bonded to the top surface of the clear outer layer, by transfer lamination techniques described previously.

### EXAMPLE 1

An 8 mil urethane sheet supported on one side by a polyester carrier was placed in a bell jar vacuum metalization apparatus. A 0.06 gram piece of indium was then placed in an evaporation boat. A vacuum was drawn and an electric current was applied to the evaporation boat. The indium piece melted by vaporization and was deposited on the urethane sheet. The vacuum chamber was vented and the sample removed. Urethane sheets of 2, 3 and 6 mil thickness were also used successfully in this process.

Clear sheets of thermoplastic material such as polycarbonate and acrylic resin were cut to the same size as the 8 mil urethane sheet. A thickness range of the clear sheet was between 10-20 mils although the acrylic as thin as 2.5 mils was used successfully. For the polycarbonate sheet a PVDF/acrylic over-laminate was laminated to the outer surface. The overlaminate comprised Kynar 500 Plus PVDF and Elvacite 2042 from Ineos. The metalized side of the urethane sheet was placed on the clear sheet of acrylic and polycarbonate. A laminating roll applied heat and pressure and was passed over the PET-supported side of the urethane sheet. This caused a permanent bond between the metalized side of the urethane and the clear sheets of polycarbonate or acrylic.

The resulting clear sheet/metal layer/urethane composite laminate was then placed in a thermoforming apparatus with the clear layer facing up. The sample was heated and a vacuum was drawn on the urethane side. The resulting product had a chrome-like appearance with a DOI greater than 99. DOI was measured on instrument Model No. 1864 SQC from ATI Systems Inc.

Measurements were taken of the 180° peel strength at two interfaces: urethane-to-injection molded ABS and polycarbonate-to-metalized urethane. The urethane-to-ABS bond was measured as 10.87 pounds per inch and the polycarbonate-to-metalized urethane bond was measured at 44.98 pounds per inch. Some of the high readings for the polycarbonate-to-metalized urethane may have been attributable to the energy required to deform the polycarbonate at a 180° angle during the test. However, both interfaces had a very strong bond. It has been found that the somewhat rigid thick top layers of the laminate provide more depth of image and a thicker protective layer for the metal layer and are harder to remove.

### EXAMPLE 2

A 2 mil urethane baseweb was metalized in line. A roll of 2 mil urethane film supported by a polyester carrier was placed in a vacuum metallization apparatus. The urethane roll was 19 inches wide. Four rolls of indium wire were also placed in the apparatus. The wire was unwound and fed into four evaporation boats. A vacuum was drawn in the apparatus, and an electric current was applied to the boats. The indium wire melted and was vaporized under the vacuum. The wire was fed continuously into the boats, and the vaporized indium was deposited on the urethane as it was unrolled. After the entire roll was coated, the vacuum chamber was vented and the roll removed.

A clear roll of thermoplastic polycarbonate was slit to the same width as the roll of metalized 2 mil urethane. The polycarbonate thickness was 7 mils. The metalized side of the 2 mil urethane film was heat and pressure laminated to the polycarbonate sheet. This resulted in a permanent bond between the metalized side of the urethane and the clear polycarbonate. Polycarbonate thicknesses of 10, 15, and 20 mils were also produced, with the same result.

A 1.0 mil PVDF/acrylic overlaminate similar to Example 1 was heat and pressure laminated to the outer surface of the polycarbonate. The resulting composite was thermoformed to a three-dimensional shape, with the urethane side contacting the mold surface. The resulting composite laminate had a chrome-like appearance and a DOI greater than 99.

### EXAMPLE 3

Samples of the construction described in Example 2 were placed in accelerated weathering apparatuses, including Xenon Weatherometer and QUV. After approx. 500 hours exposure, a haze developed on the surface of the samples. The haze grew progressively worse with time. It was believed that the haze might be UV absorber migrating to the surface of the PVDF/acrylic overlaminate film. This haze also occurred in outdoor Florida exposure after 6 months.

To solve this problem, an L9 design of experiments (DOE) was conducted to evaluate different UV absorbers in the PVDF/acrylic coating. Tinuvin 400, Tinuvin 928, and Tinuvin 900 (control) were evaluated. The same PVDF/acrylic resins as Examples 1 and 2, at the same ratio, were used. PVDF/acrylic topcoat thicknesses of 0.5, 1.0, and 2.0 mils were evaluated.

After 500 hours exposure, the L9 samples were compared. Samples with the Tinuvin 400 and 928 showed superior results to the Tinuvin 900 samples, with respect to preventing the hazing problem. The samples were then exposed to the 2000 hour level, at which point the samples with Tinuvin 928 had the best metallic appearance retention, and also had less yellowing than either the Tinuvin 400 or Tinuvin 900 samples. In addition, the 0.5 mil thick topcoats resulted in more yellowing than the 1.0 or 2.0 mil topcoats. The amount of yellowing for the 1.0 and 2.0 mil topcoats was not significantly different.

### EXAMPLE 4

During the thermoforming step in Example 2, it was noted that the formed part sometimes had a tendency to stick to the face of the thermoforming mold. This was most likely due to the urethane being heated above its melting point during the thermoforming heating cycle. This caused difficulty in removing the part from the mold, sometimes causing it to turn inside out. This part deformation also led to problems when subsequently placing the part in the injection molding apparatus.

To solve this problem, a coating was applied to the urethane side of the construction that contacted the mold surface. This coating was formed on a separate 2 mil PET carrier, using a reverse roll coating process. The resin used for the coating was polymethylmethacrylate, Elvacite 2009, supplied by Ineos. The Elvacite 2009 resin was dissolved in solvents, applied to the PET carrier, and dried to a coat weight of 6 gsm.

The dried coating was heat and pressure laminated to the 2 mil urethane film described in Example 2. The same steps of metalizing and laminating were followed as in Example 2, including the PVDF/acrylic topcoat. The resulting laminate was thermoformed. The thermoformed part released much more easily than the parts of Example 2.

### EXAMPLE 5

2 mil urethane film, as described in Example 2, was metalized in the vacuum apparatus. Clear PETG sheets were heat and pressure laminated to the metalized side of the urethane. The thicknesses of the clear PETG sheets were 10 and 15 mils, although PETG as thin as 5 mils has also been used successfully. The PETG is commercially available as Eastar 6763 from Eastman Corporation. A PVDF/acrylic clear protective topcoat, with the Tinuvin 928 UV absorber as described in Example 3, was laminated to the top side of the PETG sheet. The lamination steps created permanent bonds at the PETG/topcoat and PETG/metalized film interfaces.

The resulting composite laminate was placed in a thermoforming apparatus with the clear layer facing up. The sample was heated, and a vacuum was drawn on the urethane side. The sheet temperature of the laminate was in the 270 to 280 deg. F. range. The resulting product had a chrome-like appearance with a DOI greater than 99.

### EXAMPLE 6

A solution containing a chlorinated polyolefin (CPO), Hardlen 13-LP, was reverse roll coated on a 2 mil PET carrier. The coating was dried to a coating weight of 6 gsm. A solution containing a polyethylmethacrylate, Elvacite 2042, was coated onto the CPO coating, and also dried to a coating weight of 6 gsm.

The dried coating was heat and pressure laminated to a 2 mil urethane film as described in Example 2. The same steps of metalizing and laminating were followed as in Example 2, including applying the PVDF/acrylic topcoat. The PET carrier was removed and the resulting laminate was thermoformed to a three-dimensional shape.

The thermoformed part was placed in an injection mold, where a TPO molding material was injection molded against the dried CPO coating. The resulting part had a permanent bond between the injection molded TPO resin and the CPO-containing coating.

The above process was then repeated, except that a different CPO was used: Surflen A-1000, supplied by Nagase American Corporation. The resulting part had a permanent bond between the injection molded TPO resin and the Surflen A-1000 resin.

### EXAMPLE 7

The 1.0 mil PVDF/acrylic topcoat on PET, with the Tinuvin 928 UV absorber as described in Example 3, was gravure printed with two geometric patterns and two tint coats, for a total of four samples. The geometric patterns had approx. 10 to 30 percent coverage of the topcoat, while the tint coats covered the entire surface.

These printed samples were heat and pressure laminated to the clear sheet/metal layer/urethane composite, with polycarbonate and PETG used as the clear thermoplastic sheets. The gravure printed side of the topcoat contacted the clear thermoplastic sheet, forming a permanent bond.

The resulting printed/metalized composites were placed in a thermoforming apparatus with the printed side facing up. The samples were heated and a vacuum was drawn on the urethane side.

For the samples with the geometric patterns, the metallic appearance was still evident underneath the printing. However, there was pattern distortion in the high draw areas.

For the samples with the tint coats, the chrome-look of the metallic layer was transformed into copper and gold appearing products.

### EXAMPLE 8

The 2 mil urethane film from Example 2 was laminated to a 6 mil PETG sheet, grade 6763 from Eastman. The PETG sheet had an amber tint. A 1.0 mil PVDF/acrylic topcoat, the same as described in Example 3, was laminated to the PETG sheet, to the side opposite the urethane layer. The resulting composite was placed in a thermoforming apparatus with the topcoat side facing up. The sample was heated and a vacuum was drawn on the urethane side. The resulting product had a dark gold metallic appearance with a DOI greater than 99.

### EXAMPLE 9

A black urethane composite was made by the following process. A sheet sample of 2 mil black urethane, grade 3600, from Deerfield, was laminated to a 2 mil PET carrier. The PS8010 was an aromatic urethane. The sample was placed in a vacuum metallization apparatus. A sample of indium wire was placed in the evaporation boat. A vacuum was drawn in the apparatus, and an electric current was applied to the boat. The indium wire melted and was vaporized under the vacuum. The vaporized indium was deposited on the black urethane film. The vacuum chamber was then vented and the sample was removed.

The metalized side of the black urethane film was heat and pressure laminated to a sheet of clear 10 mil polycarbonate. A 1.0 mil PVDF/acrylic topcoat, the same as described in Example 3, was laminated to the opposite side of the laminate. The resulting composite was placed in a thermoforming apparatus with the clear coat side facing up. The sample was heated and a vacuum was drawn on the urethane side. The resulting product had a chrome-like appearance with a DOI greater than 99.

The black urethane composite provided sufficient opacity, such that an injection molded resin of any color could be used in the injection molding step, without negatively affecting the chrome-like appearance of the sample.

### EXAMPLE 10

A thick sheet PETG composite was made by the following process. The 2 mil metalized urethane film from Example 2 was laminated to a 60 mil thick sheet of clear PETG sheet, grade 6763, supplied by Eastman Corporation. A 1.0 mil PVDF/acrylic topcoat, the same as described in Example 3, was laminated to the opposite side of the composite. The resulting composite was placed in a thermoforming apparatus with the clear layer facing up. The sample was heated and a vacuum was drawn on the urethane side. The resulting product had a chrome-like appearance with a DOI greater than 99. The thermoformed part had sufficient rigidity, such that a subsequent injection molding step was unnecessary.

### EXAMPLE 11

Samples of the clear PETG, Eastman grade 6763, were obtained with levels of 2.5, 5.0, and 10.0 phr UV absorber. The samples were 27 mils thick. The 2 mil metalized urethane from Example 2 was laminated to these three samples. A 1.0 mil PVDF/acrylic topcoat, the same as described in Example 3, was laminated to the opposite side of the composite. The samples were heated and a vacuum was drawn on the urethane side. The resulting products had a chrome-like appearance with a DOI greater than 99. The PETG layers maintained their clarity throughout the lamination and thermoforming processes. The three samples were tested in QUV, along with the sample from Example 5. After 1000 hours exposure, the samples with UV absorber showed less yellowing than the non-UV absorber sample.

### EXAMPLE 12

A 2 mil sample of Deerfield 5300 aromatic grade urethane was laminated to a PET carrier. The urethane/PET sample was placed in a vacuum metallization apparatus, with a piece of indium wire in the evaporation boat. A vacuum was drawn, and the boat was heated by electric current. The indium was vapor deposited on the urethane film. The vacuum chamber was then vented and the sample was removed. Adhesion of the indium was tested using a tape test; adhesion was found to be equivalent to the Eastar 3600 grade of urethane.

The metalized 5300 urethane was heat and pressure laminated to a sheet of 10 mil clear polycarbonate. This resulted in a permanent bond between the metalized side of the urethane film and the polycarbonate sheet.

A 1.0 mil PVDF/acrylic film, the same as that described in Example 3, was laminated to the polycarbonate sheet. The resulting composite was thermoformed. The thermoformed part had a chrome-like appearance and a DOI greater than 99.

A sample of this thermoformed part, along with a thermoformed sample from Example 2 (which had 10 mil polycarbonate), were tested for 2000 hours in a Xenon Weatherometer. The sample from Example 2 had less yellowing than the sample with 5300 urethane.

### EXAMPLE 13

The laminate from Example 5 (before the thermoforming step) was heat and pressure laminated to a sample of black 11 mil ABS sheet. The resulting composite laminate was placed in a thermoforming apparatus with the clear layer facing up. The sample was heated, and a vacuum was drawn on the ABS side of the composite. The resulting product had a chrome-like appearance with a DOI greater than 99.

The thermoformed sheet was placed in an injection mold, as was a thermoformed sheet from Example 5. The injection mold configuration was such that the resin was directly molded to the underside of both constructions. The Example 5 composite had the resin penetrate the urethane and displace the metalized layer in the vicinity of the injection mold gate, while the composite with the ABS on back did not experience that problem.

1. A process for making a bright metal laminate comprising an optically clear thermoplastic and thermoformable polymeric outer layer, a highly reflective metal layer on the underside of the outer layer and visible through the outer layer, and a supporting baseweb layer to which the metal layer is applied, the baseweb comprising a flexible thermoplastic and thermoformable polyurethane film, the metal layer comprising indium or an alloy thereof, the process comprising vapor-depositing the metal layer on a surface of the baseweb to form an essentially continuous layer of reflective metal on the baseweb, and laminating the outer layer under heat and pressure to the exposed surface of the metal layer to bond the outer layer to the metal layer, the lamination step causing the polyurethane baseweb to produce adhesion of the metal layer to the baseweb in the absence of an intervening bonding layer or surface treatment while smoothing out the metal layer to a reflective finish and producing a reflective composite laminate having a distinctness-of-image greater than 95 when viewed through the clear outer layer.

2. The process according to claim 1 in which the thickness of the baseweb layer is from about 2 to about 8 mils.

3. The process according to claim 1 in which the baseweb is an extruded free film.

4. The process according to claim 1 in which the baseweb has a Shore A hardness of greater than 80; a Tg below about 0° C., and a melt point between about 90° and 110° C.

5. The process according to claim 1 in which the baseweb is an aliphatic polyester polyurethane film.

6. The process according to claim 1 in which the baseweb has a microroughened, tacky deposition surface on which the metal layer is vapor deposited.

7. The process according to claim 1 in which the metal layer has a thickness from about 200 to about 1,600 angstroms.

8. The process according to claim 1 in which the outer layer is a non-elastomeric semi-rigid sheet having a thickness from about 2.5 to about 20 mils.

9. The process according to claim 8 in which the outer layer comprises acrylic, polycarbonate, copolyester or PETG resin.

10. The process according to claim 1 in which the laminate includes a protective topcoat comprising a film of polyvinylidene fluoride and acrylic resin alloy bonded to the outer layer on a side opposite the metal layer.

11. The process according to claim 1 in which the lamination temperature is greater than the melt temperature of the metal layer and the melt temperature of the baseweb layer.

12. The process according to claim 1 in which the metal layer has an optical density from about 0.6 to about 1.6.

13. The process according to claim 1 in which the peel strength at the interface of the metal layer and the outer layer is greater than about 10 pounds per inch.

14. The process according to claim 1 including thermoforming the composite laminate to a three dimensional shape-sustaining part while the composite laminate retains the DOI at greater than 95.

15. The process according to claim 14 in which the thermoforming step causes elongation of the laminate in excess of 100% while retaining the DOI at greater than 95.

16. The process according to claim 14 including thermoforming the laminate at a sheet temperature between 270 to 370 degrees F.

17. The process according to claim 14 including molding a polymeric substrate material to a thermoformed baseweb to form a three-dimensionally shaped part.

18. The process according to claim 17 in which the interlayer bond strength between the baseweb and the molded substrate layer is greater than about 8 pounds per inch.

19. The process according to claim 17 in which the substrate material is bonded to the baseweb material by injection molding.

20. The process according to claim 17 in which the polymeric substrate material is bonded to the formed baseweb by backfilling the substrate material in a pouring operation.

21. The process according to claim 16 including applying a thermoplastic resinous mold and release coating to the baseweb prior to thermoforming.

22. The process according to claim 1 in which the laminate includes a transparent thermoplastic protective film bonded to the outer layer on a side opposite the metal layer.

23. The process according to claim 22 in which the laminate includes a print layer applied to the protective film and over-laminated to the outer layer above the metal layer.

24. The process according to claim 1 in which the outer layer has a film thickness from about 2.5 mils to about 20 mils.

25. The process according to claim 17 in which a semi-rigid thermoplastic backing sheet is bonded to the baseweb prior to thermoforming and acts as a barrier between the molding substrate material and the baseweb.

26. A bright metal film laminate comprising an optically clear polymeric outer layer, a highly reflective metal layer bonded to the underside of the outer layer and visible through the outer layer, and a flexible supporting baseweb to which the metal layer is bonded, the baseweb comprising a flexible thermoplastic and thermoformable polyurethane film, the metal layer comprising indium or an alloy thereof in direct contact with the polyurethane baseweb, the metal layer vapor deposited on the baseweb to form an essentially continuous layer of reflective metal on the baseweb, the outer layer comprising a thermoplastic and thermoformable polymeric film, in which the outer layer is a semi-rigid sheet having a thickness from about 7 to about 20 mils, the outer layer bonded to the metal layer by lamination under heat and pressure sufficient to smooth the metal layer to a reflective finish producing a composite laminate which is shape-sustaining under thermoforming and has a DOI greater than 95 when the composite laminate is viewed through the clear outer layer.

27. The laminate according to claim 26 in which the polyurethane baseweb comprises an aliphatic polyester polyurethane resin.

28. The laminate according to claim 26 in which the peel strength at the interface of the metal layer and the outer layer is greater than 10 pounds per inch.

29. The laminate according to claim 26 in which the baseweb has a Shore A hardness of greater than 80; a Tg below about 0° C., and a melt point between about 90° and 110° C.

30. The laminate according to claim 26 in which the baseweb has a microroughened, tacky deposition surface on which the metal layer is vapor deposited.

31. The laminate according to claim 26 in which the metal layer has a thickness from about 200 to about 1,600 angstroms.

32. The laminate according to claim 26 in which the outer layer is a non-elastomeric semi-rigid sheet containing acrylic, polycarbonate, copolyester or PETG resin.

33. The laminate according to claim 26 including a transparent thermoplastic protective top coat underprinted with a print pattern and over-laminated to the outer layer above the metal layer.

34. A bright metal film laminate comprising:
a flexible thermoplastic and thermoformable polyurethane baseweb having a Tg below about 0° C. and a melting temperature between about 90° C. to 110° C., a metalized layer of indium or an alloy thereof vapor deposited as an optically continuous film and bonded in direct contact with the polyurethane baseweb, the metal layer having a thickness from about 200 to about 1,600 angstroms, and a flexible thermoplastic and thermoformable non-elastomeric clear outer layer comprising a polymeric material containing acrylic, polycarbonate, copolyester or PETG resin bonded by lamination to the outer surface of the metal layer opposite the baseweb, the outer layer having a thickness from about 2.5 to about 20 mils to provide sufficient rigidity for transforming the laminate to a three-dimensional self-sustaining shape, the laminate having a DOI of at least about 95 when viewed through the clear outer layer.

35. A shaped article comprising a bright metal film laminate and polymeric substrate composite forming a three-dimensional shaped article, the bright metal film laminate comprising an optically clear polymeric outer layer, a highly reflective metal layer bonded to the underside of the outer layer and visible through the outer layer, and a flexible supporting baseweb to which the metal layer is bonded, the baseweb comprising a flexible thermoplastic and thermoformable polyurethane film, the metal layer comprising indium or an alloy thereof in direct contact with the polyurethane baseweb, the metal layer vapor deposited on the baseweb to form an essentially continuous layer of reflective metal on the baseweb, the outer layer comprising a thermoplastic and thermoformable polymeric film in which the outer layer is a semi-rigid sheet or film having a thickness from about 2.5 to about 20 mils, the outer layer bonded to the metal layer by lamination under heat and pressure sufficient to smooth the metal layer to a reflective finish producing a composite laminate having a DOI greater than 95 when the composite laminate is viewed through the clear outer layer, and a polymeric substrate sheet or layer bonded to the side of the baseweb opposite from the metalized layer, the composite laminate having been thermoformed to a self-sustaining three-dimensional shape while the exposed outer surface of the metal film laminate retains its DOI level above 95 in the finished shaped article.

36. The laminate according to claim 35 in which the melting temperature of the polyurethane baseweb is below about 330° F.

37. The shaped article according to claim 35 in which the shaped article comprises an exterior automotive trim part.

38. The shaped article according to claim 35 in which the outer layer contains acrylic, polycarbonate, copolyester or PETG resin.

39. The shaped article according to claim 38 in which the molded polymeric resin substrate material comprises a cross-linked polyurethane resin, a thermoplastic elastomer, ABS, or an acrylic resin.

40. An automotive part comprising a shaped bright metal laminate forming at least a portion of a viewable surface of the part and a structural base for supporting the shaped laminate, in which the shaped laminate has a bottom surface forming a cavity, and the structural base is formed by a hardened molded polymer material contained in the cavity, the bright metal laminate comprising an optically clear polymeric outer layer, a highly reflective metal layer on the underside of the outer layer and visible through the outer layer, and a baseweb layer to which the metal layer is applied, the baseweb comprising a flexible thermoplastic and thermoformable polyurethane film, the metal layer comprising indium or an alloy thereof, the metal layer vapor deposited on the baseweb to form a visually continuous layer of reflective metal on the baseweb, the outer layer bonded to the metal layer by lamination sufficient to smooth the metal layer to a mirror-like finish, and in which the bright metal laminate has been thermoformed to form the cavity on the baseweb side of the laminate for containing the molded substrate material.

41. The article according to claim 40 in which the three-dimensionally shaped laminate has a DOI greater than 95.

42. The article according to claim 40 in which the outer layer comprises acrylic, polycarbonate, copolyester or PETG resin.
